(19) United States
(12) Patent Application Publication
(10) Pub. No.: US 2025/0370309 A1
(43) Pub. Date: Dec. 4, 2025

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Chi-Yuan SHIH, Zhubei (TW); Wen-Shun LO, Zhudong Township (TW); Chia-Wei CHIANG, Hsinchu County (TW); Sheng Kai YEH, Taichung City (TW); Shu-Wei CHANG, Taipei City (TW); Feng YUAN, Hsinchu City (TW); Chia-Hua CHU, Zhubei City (TW); Chia-Ming HUNG, Zhubei City (TW); Yingkit Felix TSUI, Cupertino, CA (US)

(21) Appl. No.: 18/677,020

(22) Filed: May 29, 2024

(51) Int. Cl. G02F 1/225; G02F 1/21

(52) U.S. Cl. CPC G02F 1/2257; G02F 1/212

(57) ABSTRACT

A bus optical waveguide structure, an optical modulator structure, and a modulator heater structure are formed from a semiconductor layer of a semiconductor photonics device such that the bus optical waveguide structure, the optical modulator structure, and the modulator heater structure are contiguous and physically connected. The physical connection between the optical modulator structure and the modulator heater structure provides a direct path for heat to be provided from the modulator heater structure to the optical modulator structure through the semiconductor layer. An isolation region, which may include a doped region of the semiconductor layer, is included between the modulator heater structure and the bus optical waveguide structure and the optical modulator structure. The isolation region electrically isolates the modulator heater structure and the optical modulator structure. Thus, the modulator heater structure is physically connected to, and electrically isolated from, the optical modulator structure.

### BACKGROUND

A semiconductor photonics device may be configured to use optical signals for high speed and secure data transmission between integrated circuits and/or semiconductor dies of the semiconductor photonics device. An optical signal may be transferred through a bus optical waveguide in the semiconductor photonics device. The bus optical waveguide enables confinement of the optical signal, which may reduce optical loss and increase propagation efficiency for the optical signal. Data may be encoded into an optical signal by modulating light into optical pulses through an optical modulator structure. The optical pulses are then transferred to the bus optical waveguide for propagation to other regions of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1D are diagrams of example implementations of an example semiconductor photonics device described herein.

FIGS. 2A-2T are diagrams of an example implementation of forming a semiconductor photonics device (or a portion thereof) described herein.

FIG. 3 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic integrated circuit of a semiconductor photonics device may include a bus optical waveguide structure and an optical modulator structure. The bus optical waveguide structure and the optical modulator structure may be included in one or more dielectric layers of the semiconductor photonics device. The resonant wavelengths of the optical modulator structure may be sensitive to variations in processes and operating temperatures. To stabilize the resonant wavelengths of the optical modulator structure, a modulator heater structure may be located near the optical modulator structure to provide heat to the optical modulator structure. The heat provided by the modulator heater structure enables the operating temperature of the optical modulator structure to be maintained at a consistent operating temperature during operation of the semiconductor photonics device, thereby stabilizing the resonant wavelengths of the optical modulator structure.

While some of the heat generated by the modulator heater structure is transferred to the optical modulator structure, the dielectric layer(s) surrounding the modulator heater structure also absorb heat generated by the modulator heater structure (e.g., heat that could otherwise be used to heat the optical modulator structure). This results in inefficient operation of the modulator heater structure in that a greater amount of heat needs to be generated in order to compensate for the heat loss due to the heat absorbed in the dielectric layer(s), thereby increasing the power consumption of the semiconductor photonics device.

In some implementations described herein, a semiconductor photonics device includes a bus optical waveguide structure and an optical modulator structure. The bus optical waveguide structure and the optical modulator structure are formed from a semiconductor layer. A modulator heater structure is also formed from the semiconductor layer such that the bus optical waveguide structure, the optical modulator structure, and the modulator heater structure are contiguous and physically connected. The physical connection between the optical modulator structure and the modulator heater structure provides a direct path for heat to be provided from the modulator heater structure to the optical modulator structure through the semiconductor layer. The direct path, in combination with the semiconductor layer providing greater thermal conductivity than the surrounding dielectric layers, enables a high operating efficiency to be achieved for the modulator heater structure and enables the operating temperature of the modulator heater structure to be maintained with greater temperature uniformity.

An isolation region, which may include a doped region of the semiconductor layer, may be included between the modulator heater structure and the bus optical waveguide structure and the optical modulator structure. The isolation region electrically isolates the modulator heater structure and the bus optical waveguide structure and the optical modulator structure. Thus, the modulator heater structure is physically connected to, and electrically isolated from, the optical modulator structure. This enables the modulator heater structure and the optical modulator structure to operate independently of each other, and prevents, reduces, and/or minimizes interference with the operation of the optical modulator structure from the modulator heater structure.

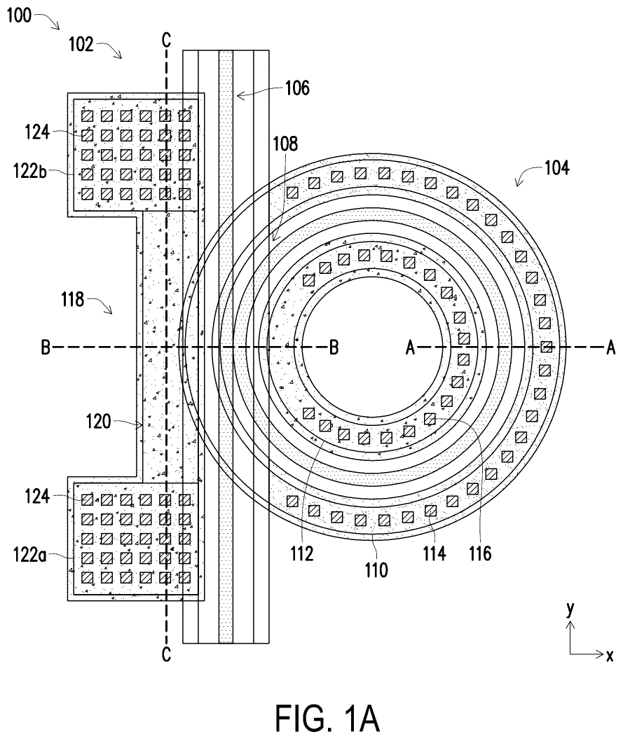

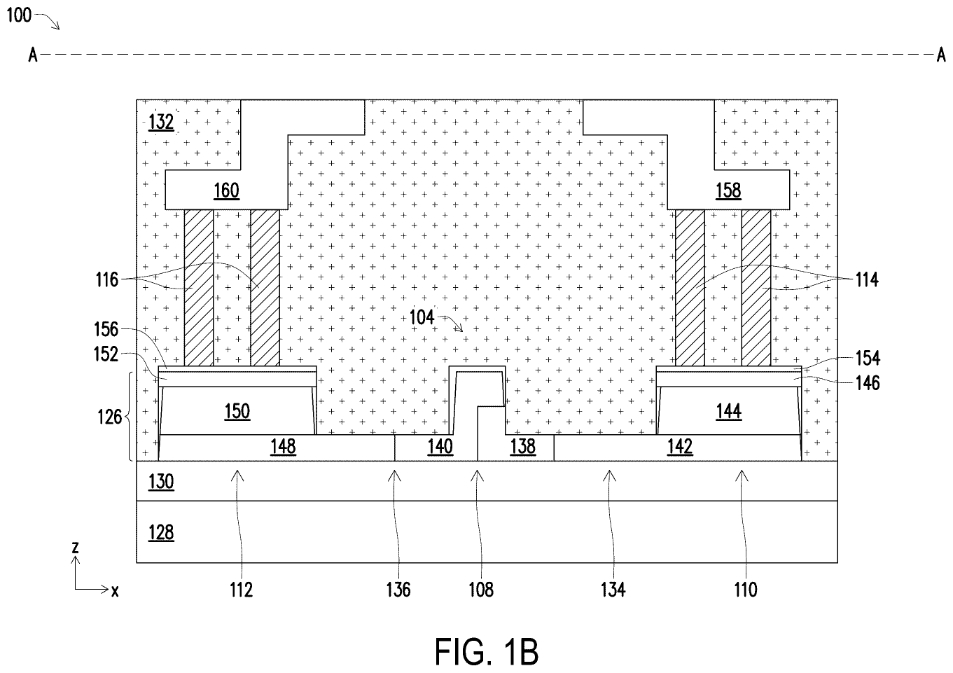

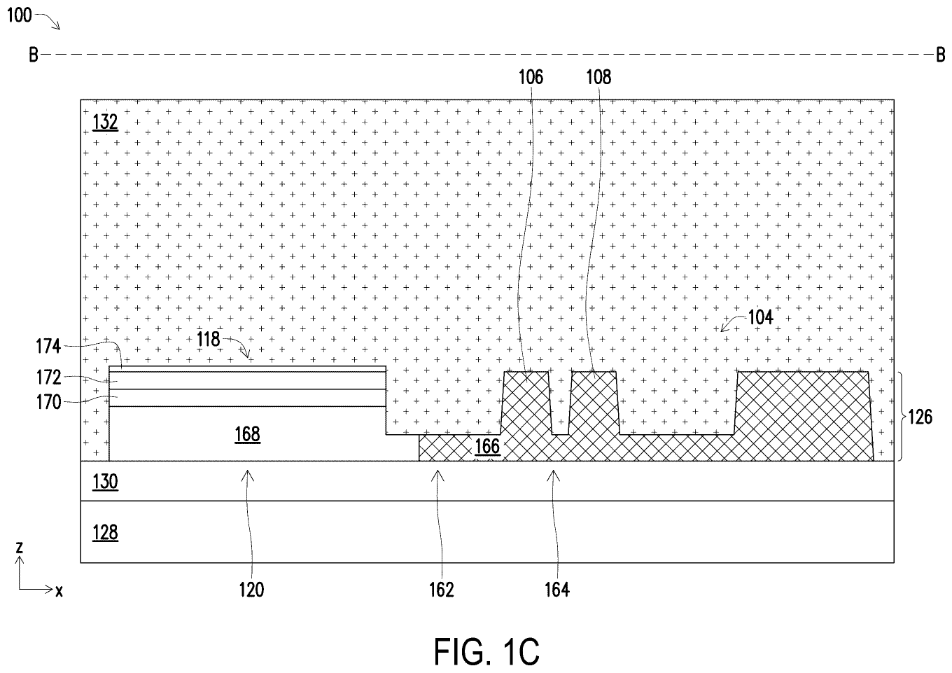

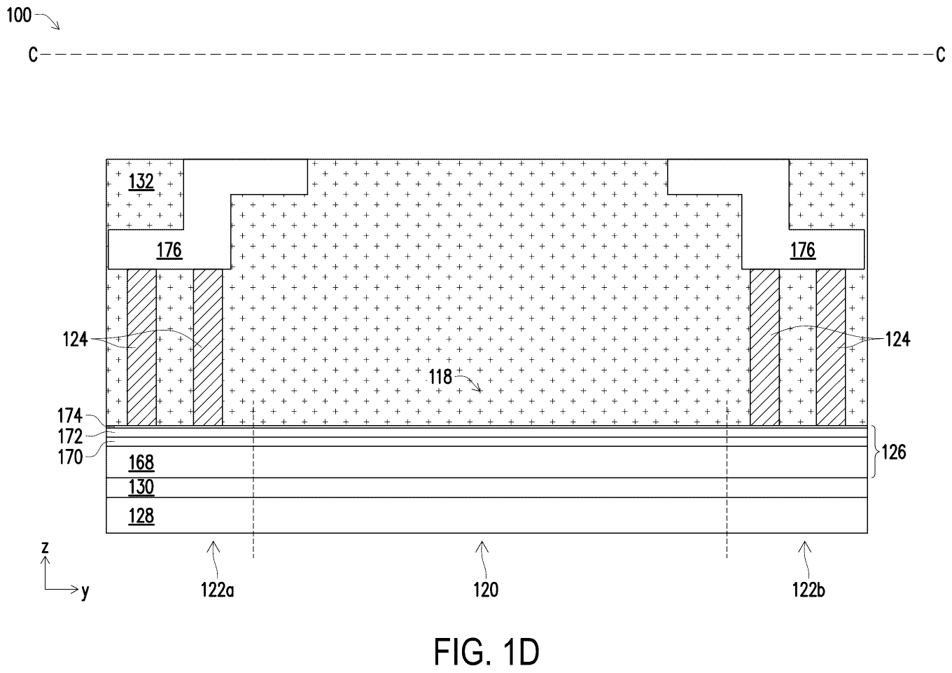

FIGS. 1A-1D are diagrams of example implementations of an example semiconductor photonics device 100 described herein. FIG. 1A illustrates a top view of the semiconductor photonics device 100. As shown in FIG. 1A, the semiconductor photonics device 100 includes a photonic integrated circuit 102. The photonic integrated circuit 102 may be configured to use optical signals for high speed and secure data transmission between integrated circuits and/or semiconductor dies of the semiconductor photonics device 100, and/or between the semiconductor photonics device 100 and another device external to the semiconductor photonics device 100. Accordingly, the photonic integrated circuit 102 may include an optical modulator structure 104 and a bus optical waveguide structure 106 optically coupled with the optical modulator structure 104.

The optical modulator structure 104 and the bus optical waveguide structure 106 may be adjacent and/or side-by-side in an x-direction in the semiconductor photonics device 100 to enable coupling of optical signals between the optical modulator structure 104 and the bus optical waveguide structure 106.

The bus optical waveguide structure 106 may extend in the y-direction along a side of the optical modulator structure 104. The bus optical waveguide structure 106 enables confinement of the optical signal, which may reduce optical loss and increase propagation efficiency for the optical signal. The bus optical waveguide structure 106 may include an elongated waveguide that includes a slab waveguide, a rib waveguide, and/or another type of waveguide structure. Input optical signals may enter the bus optical waveguide structure 106 at a first end of the bus optical waveguide structure 106, and output optical signals (e.g., modulated optical signals) may be provided from the bus optical waveguide structure 106 at a second (opposing) end of the bus optical waveguide structure 106. Optical signals may couple between the bus optical waveguide structure 106 and the optical modulator structure 104 at a coupling region where the bus optical waveguide structure 106 and the optical modulator structure 104 are laterally adjacent.

The optical modulator structure 104 includes a micro ring modulator (MRM) or another type of closed-loop modulator structure that includes a closed-loop optical waveguide structure 108. The closed-loop optical waveguide structure 108 is a continuous waveguide structure that connects to itself with no end points. The structure of the optical modulator structure 104 is different from other types of modulators such as Mach-Zender modulators (MZMs) that have end points corresponding to an input and an output. Instead of optical signals being coupled to and from an MZM through propagation of the optical signals through the input and output of the MZM, optical signals are coupled to and from the closed-loop optical waveguide structure 108 through evanescent coupling. Evanescent coupling from the bus optical waveguide structure 106 and the closed-loop optical waveguide structure 108 occurs when the evanescent field of the optical signals propagating through the bus optical waveguide structure 106 extends into the portion of the closed-loop optical waveguide structure 108 that is adjacent to the bus optical waveguide structure 106. Similarly, evanescent coupling from the closed-loop optical waveguide structure 108 to the bus optical waveguide structure 106 occurs when the evanescent field of the optical signals propagating through the closed-loop optical waveguide structure 108 extends into the portion of the bus optical waveguide structure 106.

The optical modulator structure 104 may function as a resonance chamber and may modulate input optical signals coupled from the bus optical waveguide structure 106 to generate modulated optical signals that are coupled back to the bus optical waveguide structure 106. The optical modulator structure 104 includes a cathode 110 and anode 112 on opposing sides of the closed-loop optical waveguide structure 108. The cathode 110 may be included around and outside of the perimeter of the closed-loop optical waveguide structure 108, and the anode 112 may be included around and within the perimeter of the closed-loop optical waveguide structure 108. The electrical inputs (e.g., a voltage, a current) may be applied to the cathode 110 and/or the anode 112 to modify a refractive index of the material of the closed-loop optical waveguide structure 108, which enables the input optical signals to be modulated in the closed-loop optical waveguide structure 108. The cathode 110 may be electrically connected and/or physically connected with one or more contacts 114, and the anode 112 may be electrically connected and/or physically connected with one or more contacts 116. The contacts 114 and 116 enable the electrical inputs to be respectively applied to the cathode 110 and the anode 112.

As further shown in FIG. 1A, the photonic integrated circuit 102 includes a modulator heater structure 118. The modulator heater structure 118 may be located laterally and/or horizontally adjacent to the bus optical waveguide structure 106 in the x-direction such that the bus optical waveguide structure 106 is located between the modulator heater structure 118 and the optical modulator structure 104. Thus, the optical modulator structure 104, the bus optical waveguide structure 106, and the modulator heater structure 118 are arranged in the x-direction such that the modulator heater structure 118 is adjacent to a first side of the bus optical waveguide structure 106 in the x-direction, and the optical modulator structure 104 is adjacent to a second side of the bus optical waveguide structure 106 opposing the first side in the x-direction. The modulator heater structure 118 may extend in the y-direction alongside and approximately parallel to the bus optical waveguide structure 106.

The modulator heater structure 118 includes a heater section 120 and heater terminals 122a and 122b at opposing ends of the heater section 120 in the y-direction. The heater section 120 is configured to generate and provide heat to the optical modulator structure 104. The heater section 120 may be configured to generate heat through resistive heating. For example, an electrical input (e.g., a current, a voltage) may be applied to the heater terminal 122a and/or the heater terminal 122b, and the heater section 120 converts the electrical input from electrical energy to thermal energy (e.g., heat). The electrical input may be provided to the heater terminals 122a and 122b through contacts 124.

The heater section 120 may be elongated in the y-direction such that the opposing ends of the heater section 120 at least extend to, and are approximately aligned with, opposing sides of the closed-loop optical waveguide structure 108 of the optical modulator structure 104. This enables the heater section 120 to distribute heat fully across the diameter of the closed-loop optical waveguide structure 108 of the optical modulator structure 104. In some implementations, one or more of the ends of the heater section 120 extend in the y-direction past one or more sides of the closed-loop optical waveguide structure 108.

The heater terminals 122a and 122b may have a greater x-direction width than the x-direction width of the heater section 120. This increases the heat generation performance of the heater section 120 in that the narrowing of the flow path of the electrical input between the heater terminals 122a and 122b through the heater section 120 increases the resistivity of the heater section 120, resulting in a greater amount of heat being generated than if the x-direction width of the heater section 120 were approximately equal to or greater than the x-direction width of the heater terminals 122a and 122b.

FIG. 1B illustrates a cross-section view of the semiconductor photonics device 100 along the line A-A in FIG. 1A, which is across a section of the optical modulator structure 104 in the x-direction. As shown in FIG. 1B, the optical modulator structure 104 may be formed and/or included in a semiconductor layer 126 that is located above a semiconductor substrate 128 and a first dielectric layer 130 in a z-direction in the semiconductor photonics device 100. The semiconductor layer 126 may include a layer of silicon (Si) material, germanium (Ge) material, and/or another semiconductor material. The semiconductor substrate 128 may include the same semiconductor material as the semiconductor layer 126, or may include a different semiconductor material. The first dielectric layer 130 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

A second dielectric layer 132 may be included above the first dielectric layer 130 such that the optical modulator structure 104 is encapsulated by the first dielectric layer 130 and the second dielectric layer 132. The second dielectric layer 132 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

As shown in FIG. 1B, the optical modulator structure 104 includes a plurality of sections in the semiconductor layer 126, including the cathode 110, the anode 112, and the closed-loop optical waveguide structure 108. The closed-loop optical waveguide structure 108 may be located between the cathode 110 and the anode 112, and may be electrically connected and/or physically connected with the cathode 110 and the anode 112 through connector sections 134 and 136, respectively.

The semiconductor layer 126 may have different z-direction thicknesses in the optical modulator structure 104. For example, the z-direction thickness of the semiconductor layer 126 in the cathode 110 and in the anode 112 may be greater than the z-direction thickness of the semiconductor layer 126 in the connector sections 134 and 136. As another example, the z-direction thickness of the semiconductor layer 126 in the closed-loop optical waveguide structure 108 may be greater than the z-direction thickness of the semiconductor layer 126 in the connector sections 134 and 136. The connector sections 134 and 136 enable the electrical inputs to be applied to the closed-loop optical waveguide structure 108 to modify the refractive index in the closed-loop optical waveguide structure 108 for modulating input optical signals.

As further shown in FIG. 1B, a plurality of regions of the semiconductor layer 126 may be doped to form a P-N junction (p-type/n-type junction) or a P-I-N (p-type/intrinsic/n-type junction) in the closed-loop optical waveguide structure 108. When the electrical inputs are applied to the cathode 110 and the anode 112, the P-N junction (or P-I-N junction) causes an electric field to form in the closed-loop optical waveguide structure 108, and the electric field modifies the refractive index of the closed-loop optical waveguide structure 108.

The plurality of regions of the semiconductor layer 126 include a doped region 138 and a doped region 140 that are included in the closed-loop optical waveguide structure 108. A portion of the doped region 138 is also included in the connector section 134, and a portion of the doped region 140 is also included in the connector section 136. The plurality of regions of the semiconductor layer 126 may further include a doped region 142, a doped region 144, and a doped region 146 included in the cathode 110. A portion of the doped region 142 may also be included in the connector section 134. The plurality of regions of the semiconductor layer 126 may further include a doped region 148, a doped region 150, and a doped region 152 included in the anode 112. A portion of the doped region 148 may also be included in the connector section 136

In some implementations, the doped regions 138, 142, 144, and 146 include n-type doped regions (e.g., regions of the semiconductor layer 126 that are doped with one or more n-type dopants). The n-type dopants may include phosphorous (P), arsenic (As), and/or antimony (Sb), among other examples. In some implementations, the doped regions 140, 148, 150, and 152 include p-type doped regions (e.g., regions of the semiconductor layer 126 that are doped with one or more p-type dopants). The p-type dopants may include boron (B), aluminum (Al), and/or gallium (Ga), among other examples. Alternatively, the doped regions 138, 142, 144, and 146 include p-type doped regions, and the doped regions 140, 148, 150, and 152 include n-type doped regions.

The doped region 142 may have a greater dopant concentration than the doped region 138 to facilitate the flow of electrical current from the cathode 110 to closed-loop optical waveguide structure 108, to achieve low optical loss for the closed-loop optical waveguide structure 108, and/or to achieve a high modulation efficiency for the closed-loop optical waveguide structure 108, among other examples. In some implementations, the dopant concentration in the doped region 138 is included in a range of approximately 5×10¹³ atoms per cubic centimeter to approximately 5×10¹⁴ atoms per cubic centimeter, whereas the dopant concentration in the doped region 142 is included in a range of approximately 1×10¹⁴ atoms per cubic centimeter to approximately 1×10¹⁵ atoms per cubic centimeter. However, other values and/or ranges for the dopant concentrations of the doped regions 138 and 142 are within the scope of the present disclosure.

The doped region 146 may have a greater dopant concentration than the doped region 144 to achieve a low contact resistance for the cathode 110, to achieve low optical loss for the closed-loop optical waveguide structure 108, and/or to achieve a high modulation efficiency for the closed-loop optical waveguide structure 108, among other examples. In some implementations, the dopant concentration in the doped region 144 is included in a range of approximately 5×10¹³ atoms per cubic centimeter to approximately 5×10¹⁴ atoms per cubic centimeter, whereas the dopant concentration in the doped region 146 is included in a range of approximately 1×10¹⁵ atoms per cubic centimeter to approximately 5×10¹⁵ atoms per cubic centimeter. However, other values and/or ranges for the dopant concentrations of the doped regions 144 and 146 are within the scope of the present disclosure.

The doped region 148 may have a greater dopant concentration than the doped region 140 to facilitate the flow of electrical current from the anode 112 to closed-loop optical waveguide structure 108, to achieve low optical loss for the closed-loop optical waveguide structure 108, and/or to achieve a high modulation efficiency for the closed-loop optical waveguide structure 108, among other examples. In some implementations, the dopant concentration in the doped region 140 is included in a range of approximately 5×10¹³ atoms per cubic centimeter to approximately 5×10¹⁴ atoms per cubic centimeter, whereas the dopant concentration in the doped region 148 is included in a range of approximately 1×10¹⁴ atoms per cubic centimeter to approximately 1×10¹⁵ atoms per cubic centimeter. However, other values and/or ranges for the dopant concentrations of the doped regions 140 and 148 are within the scope of the present disclosure.

The doped region 152 may have a greater dopant concentration than the doped region 150 to achieve a low contact resistance for the anode 112, to achieve low optical loss for the closed-loop optical waveguide structure 108, and/or to achieve a high modulation efficiency for the closed-loop optical waveguide structure 108, among other examples. In some implementations, the dopant concentration in the doped region 150 is included in a range of approximately 5×10¹³ atoms per cubic centimeter to approximately 5×10¹⁴ atoms per cubic centimeter, whereas the dopant concentration in the doped region 152 is included in a range of approximately 1×10¹⁵ atoms per cubic centimeter to approximately 5×10¹⁵ atoms per cubic centimeter. However, other values and/or ranges for the dopant concentrations of the doped regions 150 and 152 are within the scope of the present disclosure.

As further shown in FIG. 1B, a silicide layer 154 may be included over and/or on the doped region 146 of the cathode 110, and/or a silicide layer 156 may be included over and/or on the doped region 152 of the anode 112. The silicide layer 154 and the silicide layer 156 may each include a metal silicide layer such as a titanium silicide and/or another type of metal silicide. The silicide layer 154 may be included to achieve a sufficiently low contact resistance between the doped region 146 of the cathode 110 and the contacts 114 that are electrically coupled with the cathode 110. The silicide layer 156 may be included to achieve a sufficiently low contact resistance between the doped region 152 of the anode 112 and the contacts 116 that are electrically coupled with the anode 112.

The contacts 114 and 116 may each be included in, and may extend through, the second dielectric layer 132. The contacts 114 may extend between, and may be electrically connected and/or physically connected with, the silicide layer 154 and a metallization layer 158 above the optical modulator structure 104. The contacts 116 may extend between, and may be electrically connected and/or physically connected with, the silicide layer 156 and a metallization layer 160 above the optical modulator structure 104.

The contacts 114 and 116, and the metallization layers 158 and 160, may each include tungsten (W), cobalt (Co), ruthenium (Ru), titanium (Ti), aluminum (Al), copper (Cu) or gold (Au), among other examples of conductive materials. The contacts 114 and 116 may each include vias, trenches, contact plugs, and/or another type of conductive structures. The metallization layers 158 and 160 may each include vias, trenches, contact plugs, and/or another type of metallization layers.

FIG. 1C illustrates another cross-section view of the semiconductor photonics device 100 along the line B-B in FIG. 1A, which is across a section of the optical modulator structure 104, a section of the bus optical waveguide structure 106, and across a section of the heater section 120 of the modulator heater structure 118 in the x-direction. As shown in FIG. 1C, the closed-loop optical waveguide structure 108 of the optical modulator structure 104, the bus optical waveguide structure 106, and the heater section 120 of the modulator heater structure 118 are formed and/or included together in the semiconductor layer 126. Thus, the optical modulator structure 104, the bus optical waveguide structure 106, and the modulator heater structure 118 are physically connected together in the semiconductor layer 126. The bus optical waveguide structure 106 and the modulator heater structure 118 are connected by a connector section 162 of the semiconductor layer 126, and the optical modulator structure 104 and the bus optical waveguide structure 106 are connected by a connector section 164 of the semiconductor layer 126. The z-direction thickness of the semiconductor layer 126 in the bus optical waveguide structure 106, in the closed-loop optical waveguide structure 108, and in the heater section 120 of the modulator heater structure 118 may be greater than the z-direction thickness of the semiconductor layer 126 in the connector sections 162 and 164.

Heat may be provided from the heater section 120 of the modulator heater structure 118 to the optical modulator structure 104 through the connector sections 162 and 164. In other words, heat may be provided from the heater section 120 of the modulator heater structure 118 directly to the optical modulator structure 104 through the semiconductor layer 126, as opposed to through an intervening dielectric layer (e.g., the first dielectric layer 130 and/or the second dielectric layer 132). This may enable the modulator heater structure 118 to provide heat to the optical modulator structure 104 with greater thermal efficiency than providing the heat through a dielectric layer, because the semiconductor material of the semiconductor layer 126 has greater thermal conductivity.

The section of the closed-loop optical waveguide structure 108 of the optical modulator structure 104 and the section of the bus optical waveguide structure 106 in the cross-section view along the line B-B may include an un-doped region 166 of the semiconductor layer 126. The connector section 164 between the bus optical waveguide structure 106 and closed-loop optical waveguide structure 108, and at least a portion of the connector section 164 between the bus optical waveguide structure 106 and the heater section 120 of the modulator heater structure 118, may each include the un-doped region 166 of the semiconductor layer 126.

An isolation region 168 is included in the semiconductor layer 126 between the heater section 120 of the modulator heater structure 118, and the bus optical waveguide structure 106 and the closed-loop optical waveguide structure 108 of the optical modulator structure 104. The isolation region 168 includes a doped region of the semiconductor layer 126 that is doped with a different dopant type than doped regions 170 and 172 of the semiconductor layer 126 included in the modulator heater structure 118. For example, the isolation region 168 may be doped with n-type dopants, and the doped regions 170 and 172 may be doped with p-type dopants. As another example, the isolation region 168 may be doped with p-type dopants, and the doped regions 170 and 172 may be doped with n-type dopants. This forms a P-N junction between the isolation region 168 and the doped regions 170 and 172. The P-N junction functions as a diode between the heater section 120 of the modulator heater structure 118, and the bus optical waveguide structure 106 and the closed-loop waveguide modulator structure 108 of the optical modulator structure 104. The P-N junction prevents, minimizes, and/or reduces the flow of electrical current between the heater section 120 of the modulator heater structure 118, and the bus optical waveguide structure 106 and the closed-loop waveguide modulator structure 108 of the optical modulator structure 104. Thus, the isolation region 168 electrically isolates the heater section 120 of the modulator heater structure 118 from the bus optical waveguide structure 106 and the closed-loop waveguide modulator structure 108 of the optical modulator structure 104.

The doped regions 170 and 172 of the modulator heater structure 118 may be included above the isolation region 168 in the z-direction such that the doped regions 170 and 172 and the isolation region 168 are vertically arranged in the modulator heater structure 118. In some implementations, the isolation region 168 has a dopant concentration that is included in a range of approximately 5×10¹³ atoms per cubic centimeter to approximately 5×10¹⁴ to provide sufficient electrical isolation between the heater section 120 of the modulator heater structure 118 and the bus optical waveguide structure 106 and the closed-loop waveguide modulator structure 108 of the optical modulator structure 104. However, other values and/or ranges for the dopant concentration of the isolation region 168 are within the scope of the present disclosure. The doped region 172 may have a greater dopant concentration than the doped region 170 to achieve a low contact resistance for the modulator heater structure 118. In some implementations, the dopant concentration in the doped region 170 is included in a range of approximately 5×10¹³ atoms per cubic centimeter to approximately 5×10¹⁴ atoms per cubic centimeter, whereas the dopant concentration in the doped region 172 is included in a range of approximately 1×10¹⁵ atoms per cubic centimeter to approximately 5×10¹⁵ atoms per cubic centimeter. However, other values and/or ranges for the dopant concentrations of the doped regions 170 and 172 are within the scope of the present disclosure.

As further shown in FIG. 1C, a silicide layer 174 may be included over and/or on the doped region 172 of the modulator heater structure 118. The silicide layer 174 and the silicide layer 156 may each include a metal silicide layer such as a titanium silicide and/or another type of metal silicide. The silicide layer 174 may be included to achieve a sufficiently low contact resistance for the modulator heater structure 118.

FIG. 1D illustrates another cross-section view of the semiconductor photonics device 100 along the line C-C in FIG. 1A, which is along the modulator heater structure 118 in the y-direction. As shown in FIG. 1C, sets of contacts 124 may be included at opposing ends of the modulator heater structure 118. For example, one or more first contacts 124 may be electrically connected and/or physically connected with the heater terminal 122a at a first end of the heater section 120, and one or more second contacts 124 may be electrically connected and/or physically connected with the heater terminal 122b at a first end of the heater section 120.

The contacts 124 may each be included in, and may extend through, the second dielectric layer 132. The contacts 124 may extend between, and may be electrically connected and/or physically connected with, the silicide layer 174 and a metallization layer 176 above the modulator heater structure 118. The contacts 124 and the metallization layers 176 may each include tungsten (W), cobalt (Co), ruthenium (Ru), titanium (Ti), aluminum (Al), copper (Cu) or gold (Au), among other examples of conductive materials. The contact 124 may each include vias, trenches, contact plugs, and/or another type of conductive structures. The metallization layers 176 may each include vias, trenches, contact plugs, and/or another type of metallization layers.

As indicated above, FIGS. 1A-1D are provided as an example. Other examples may differ from what is described with regard to FIGS. 1A-1D.

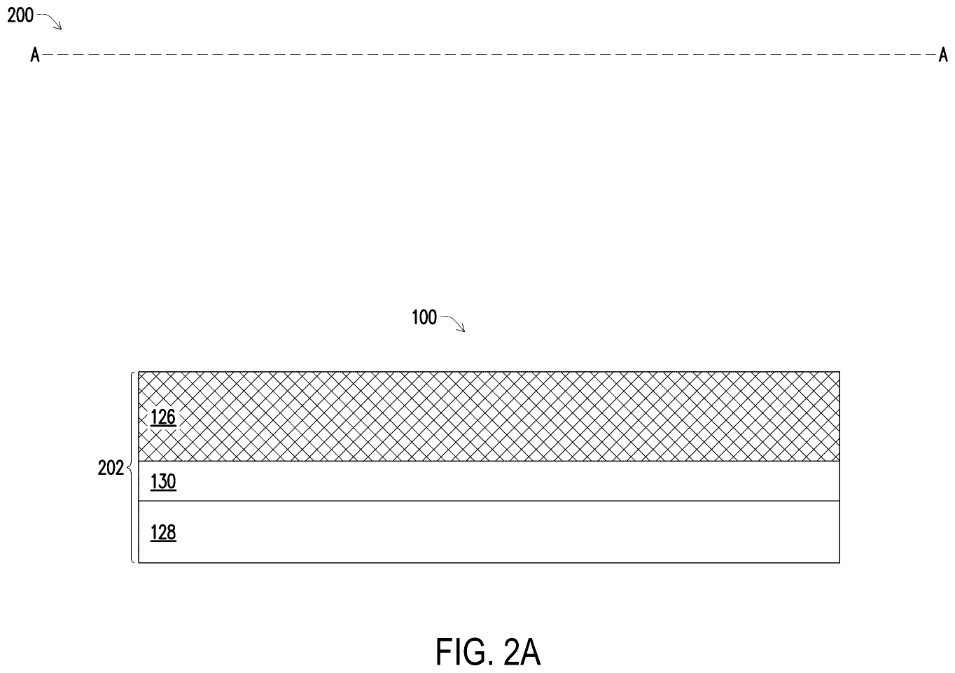

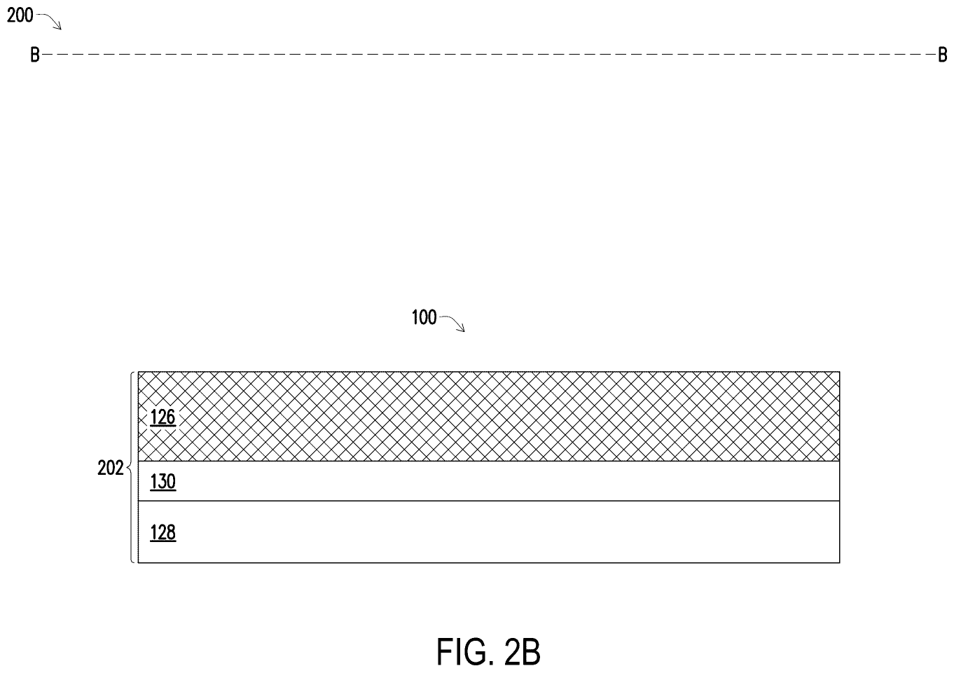

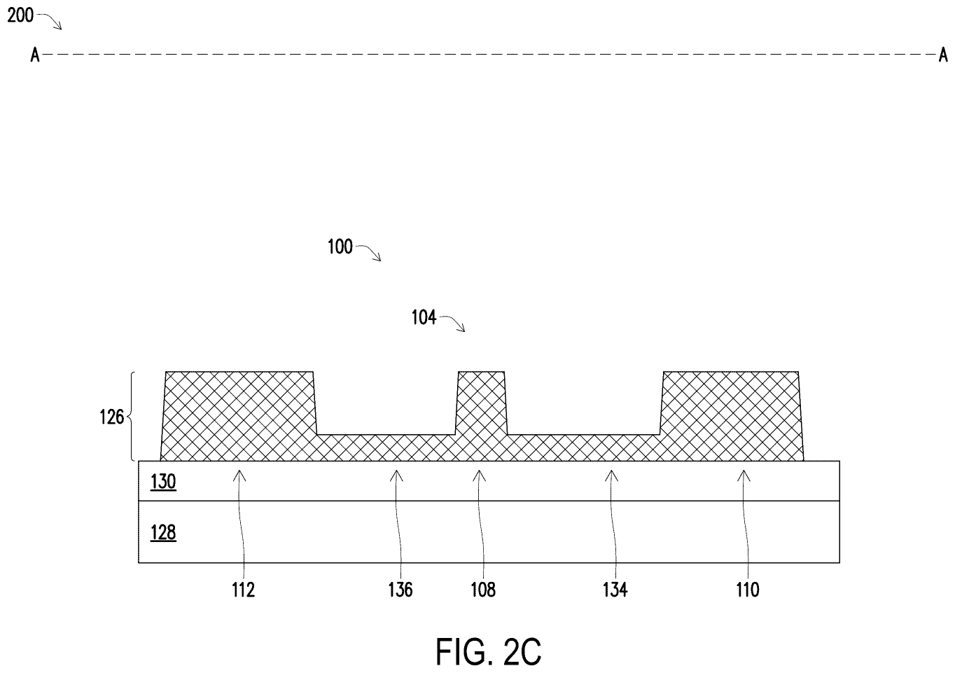

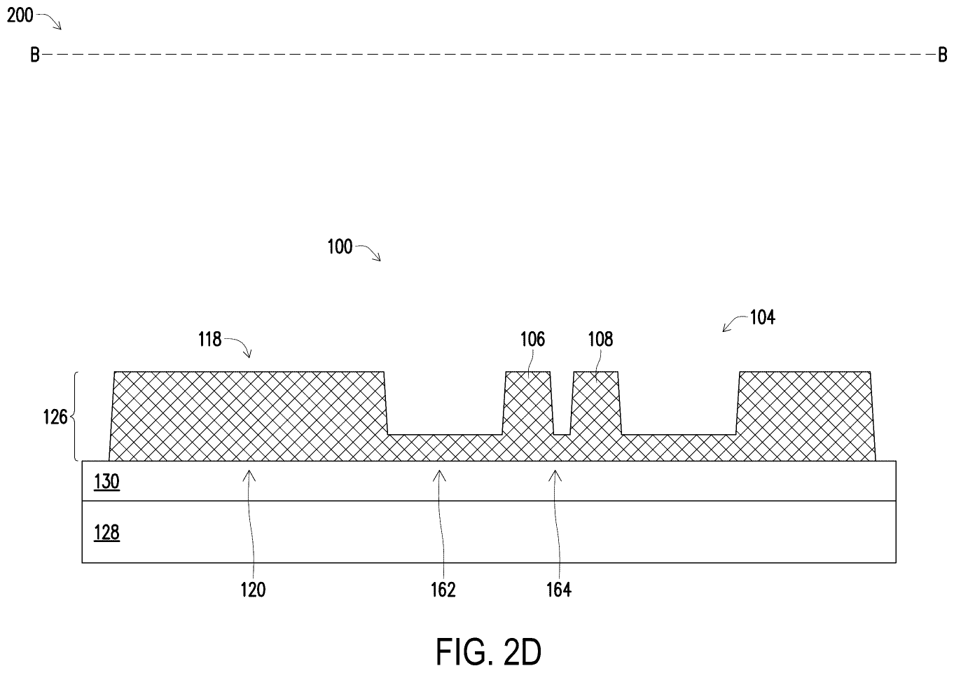

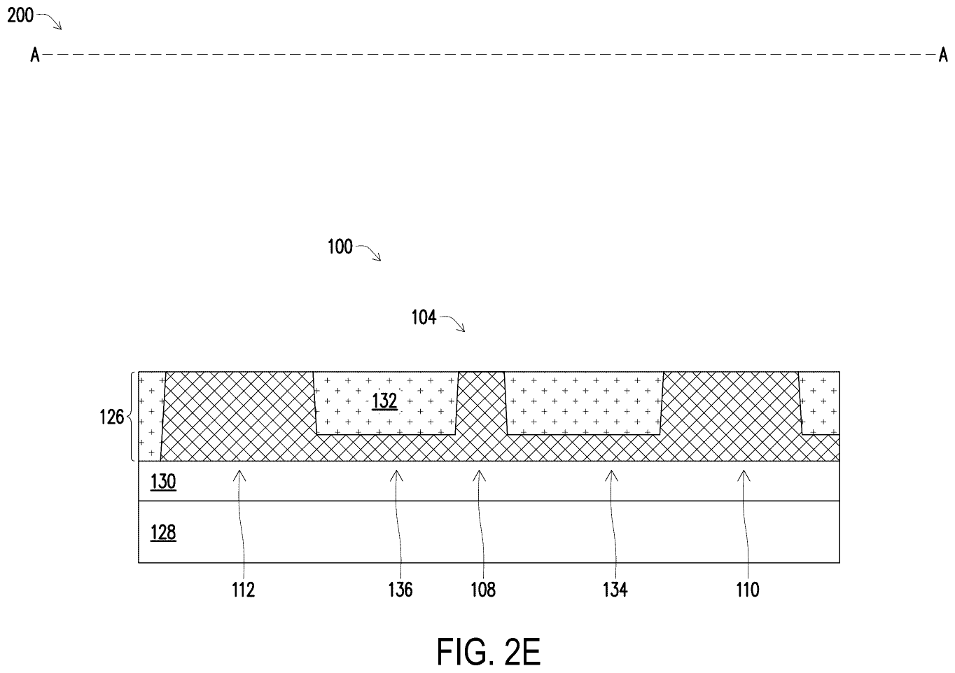

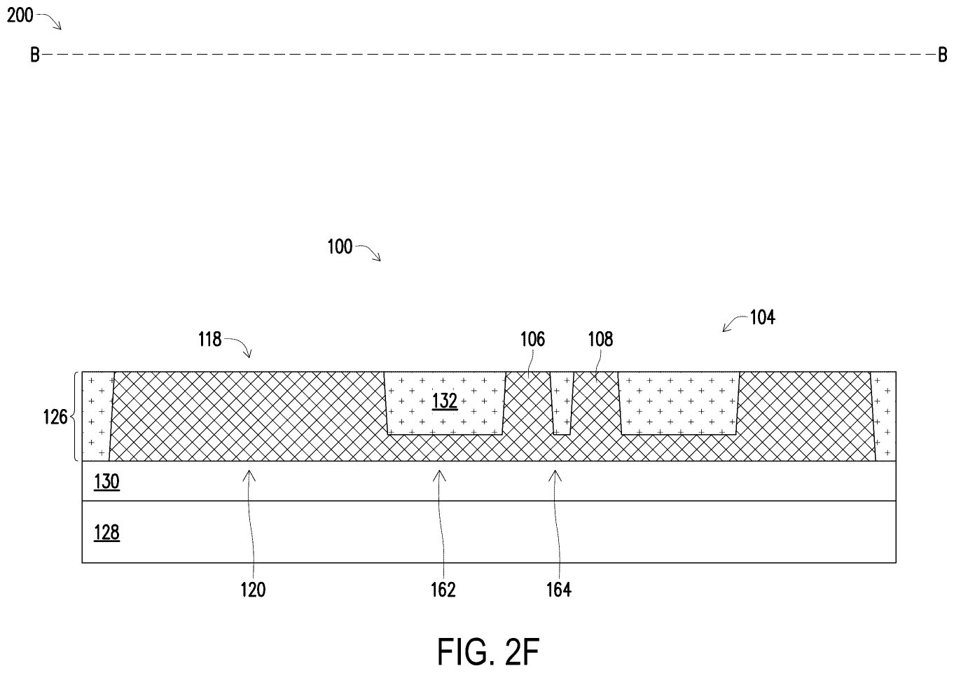

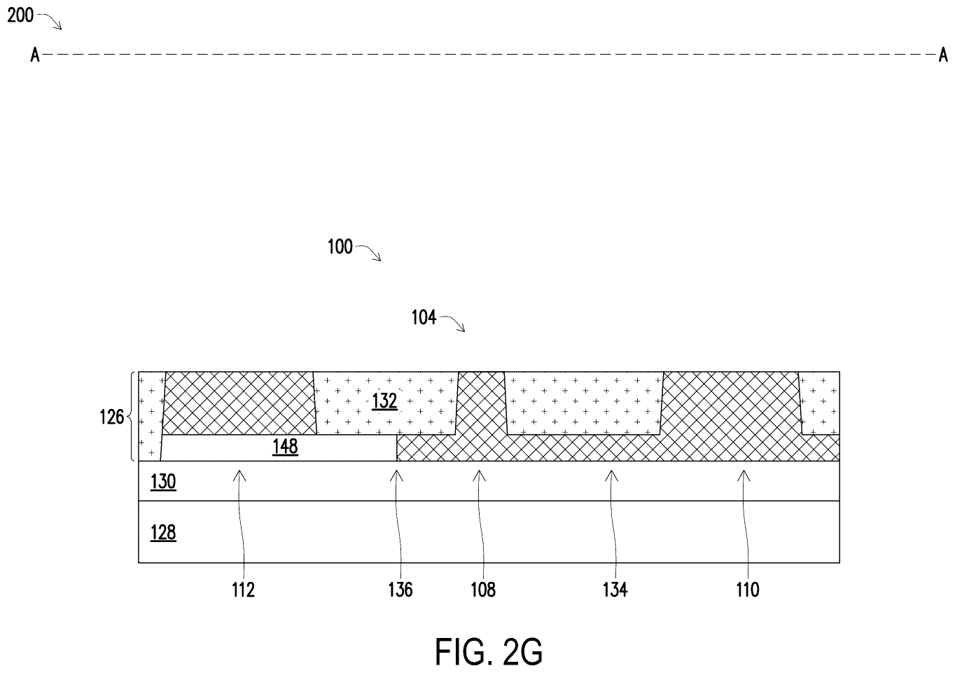

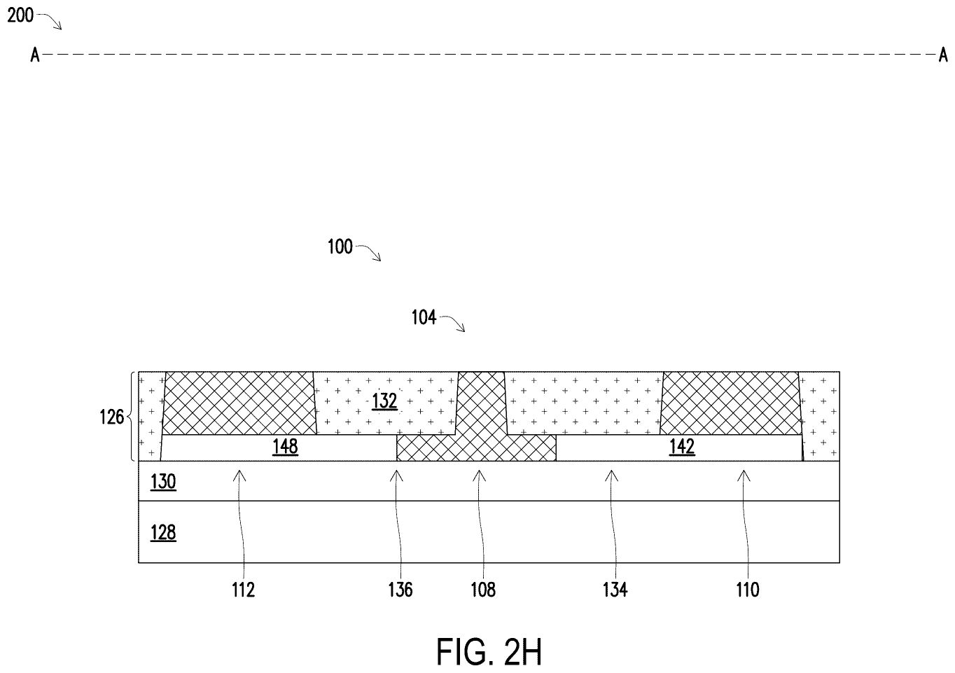

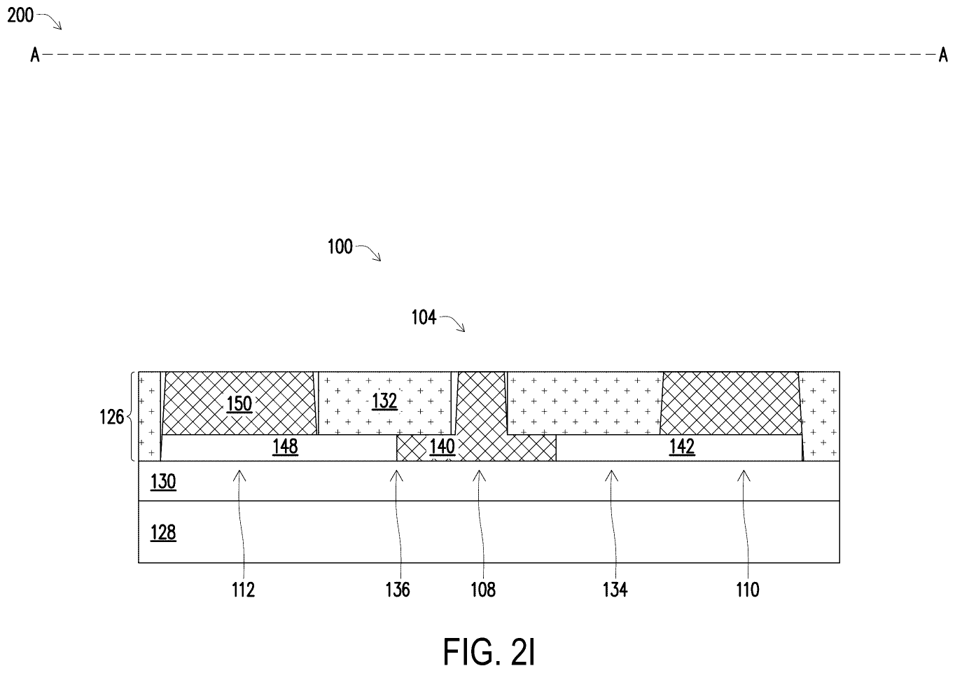

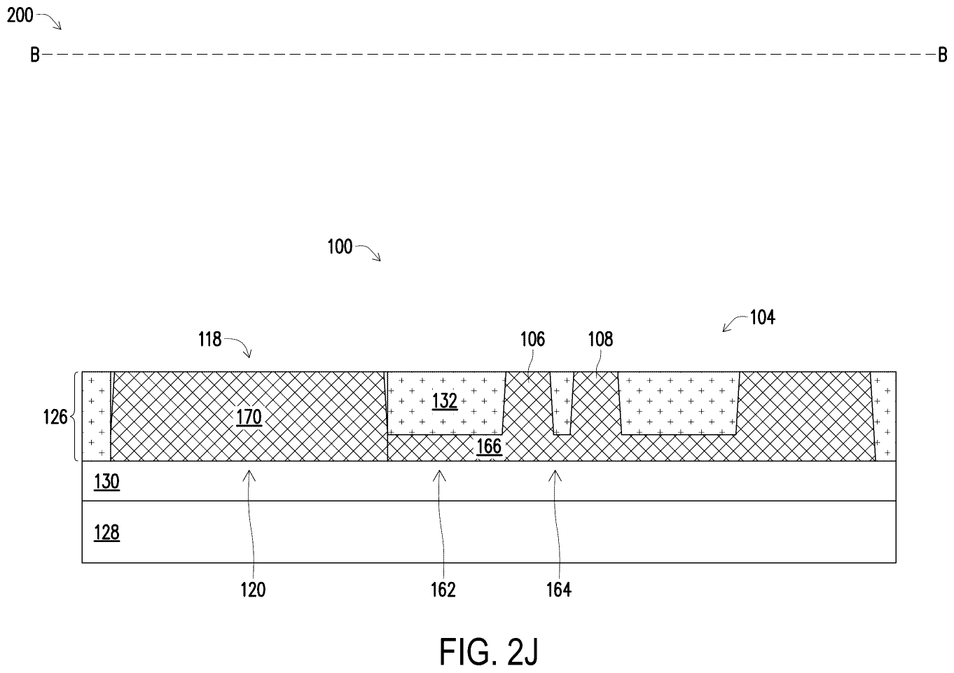

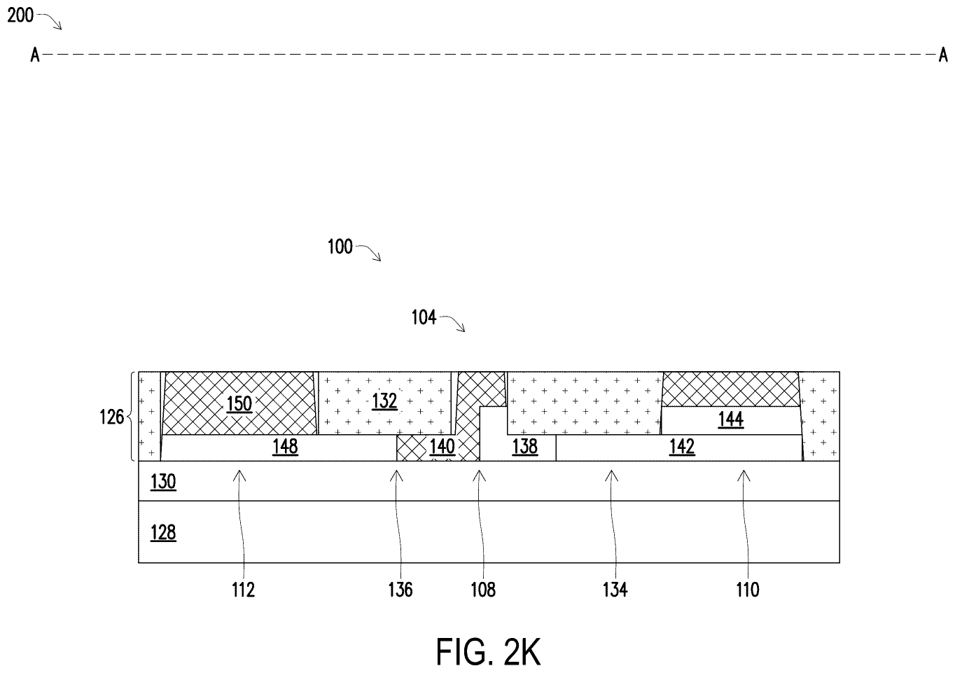

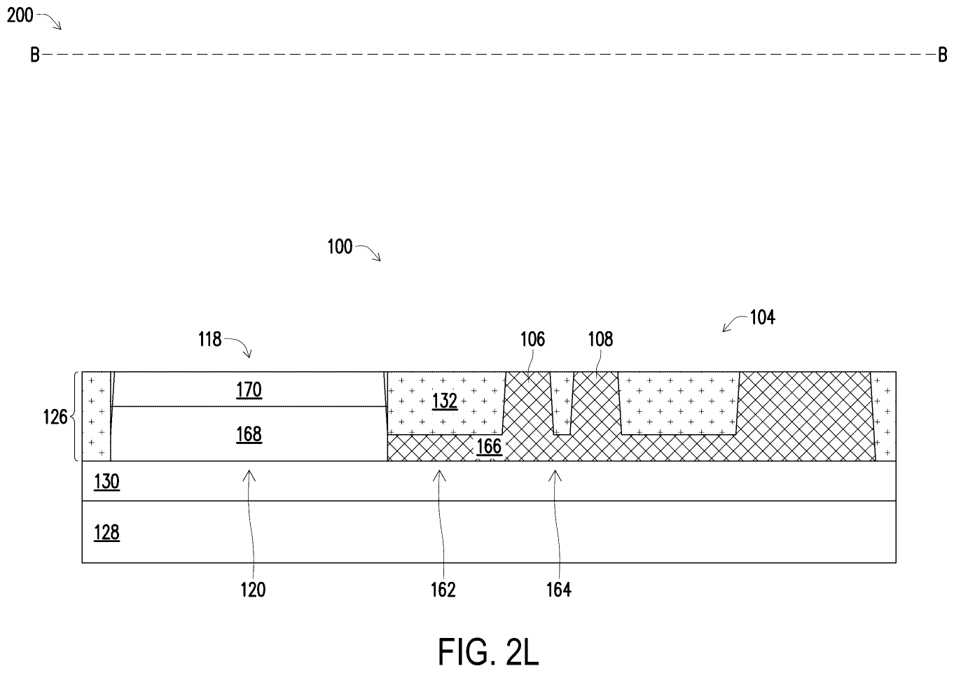

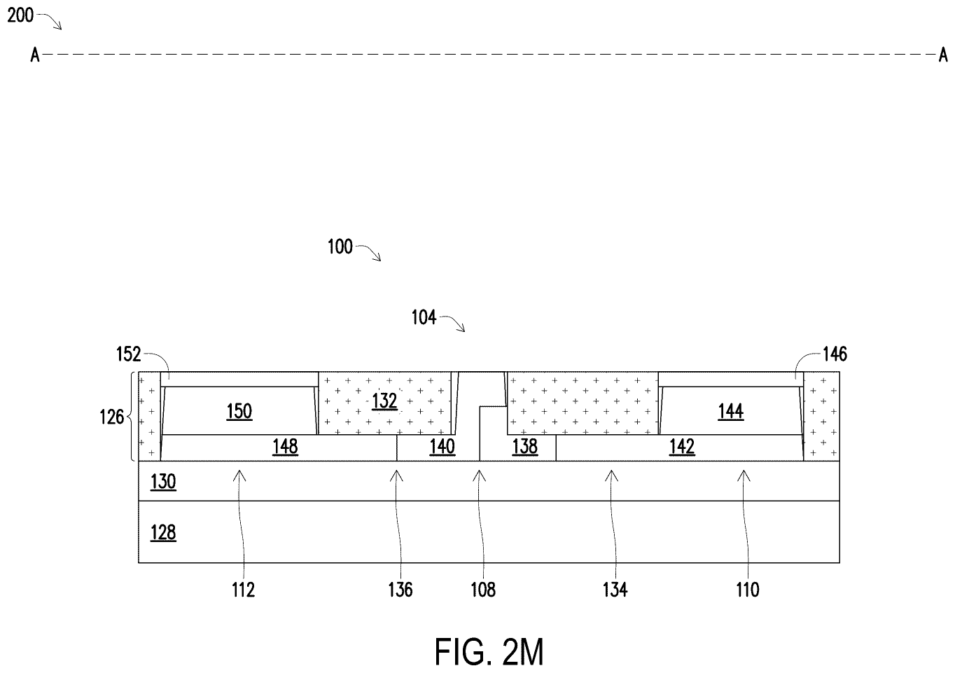

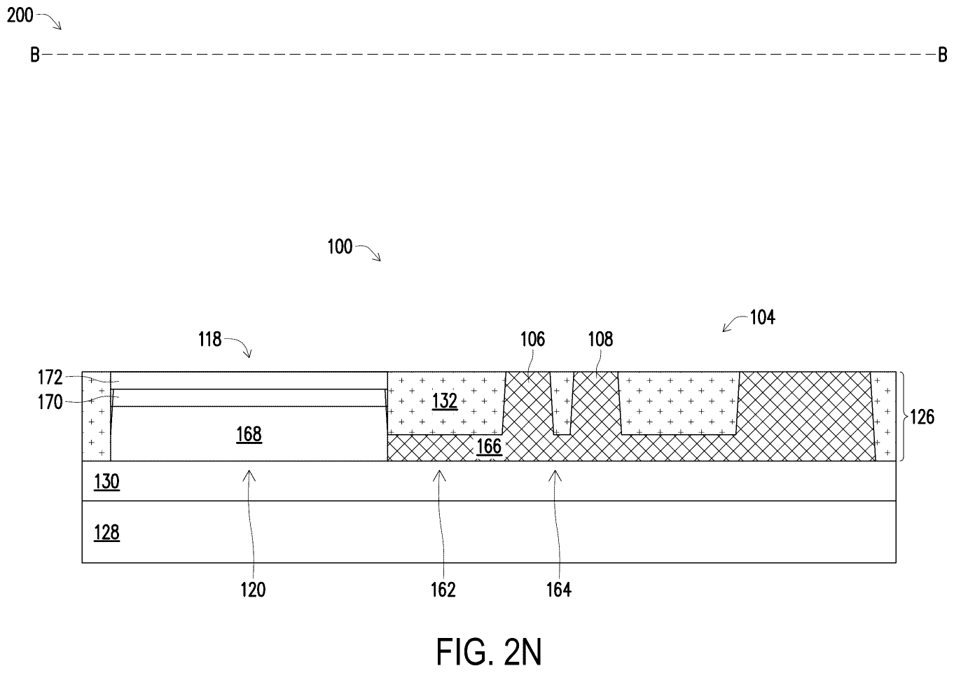

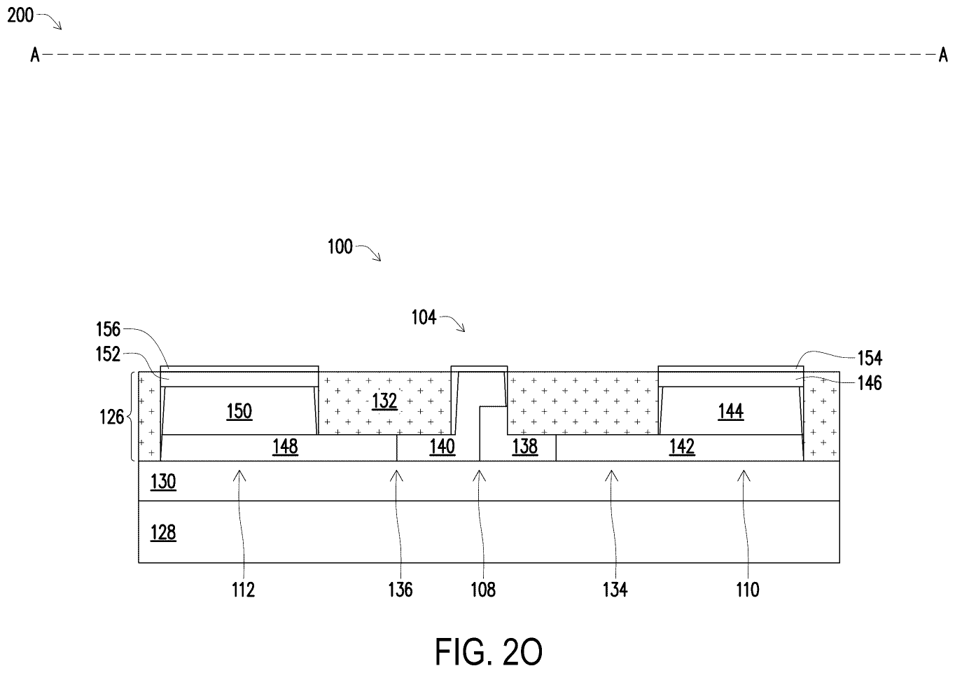

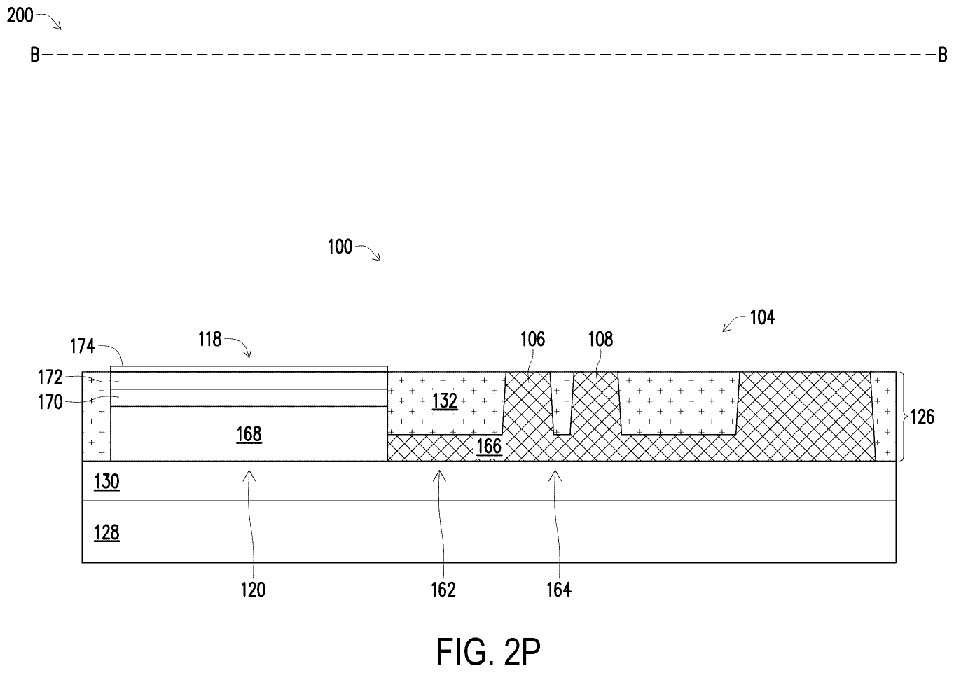

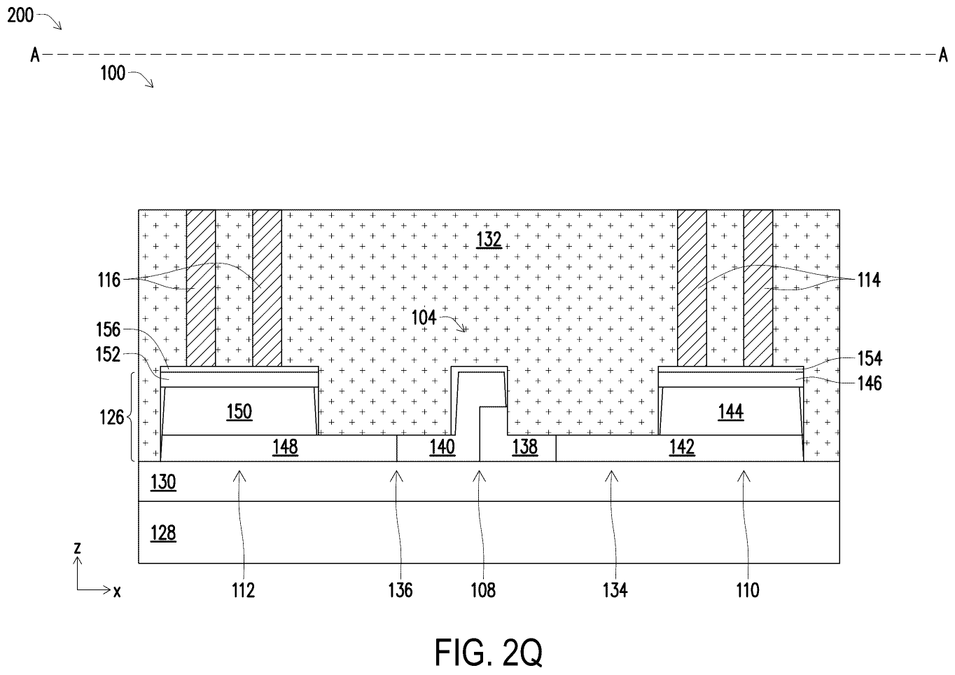

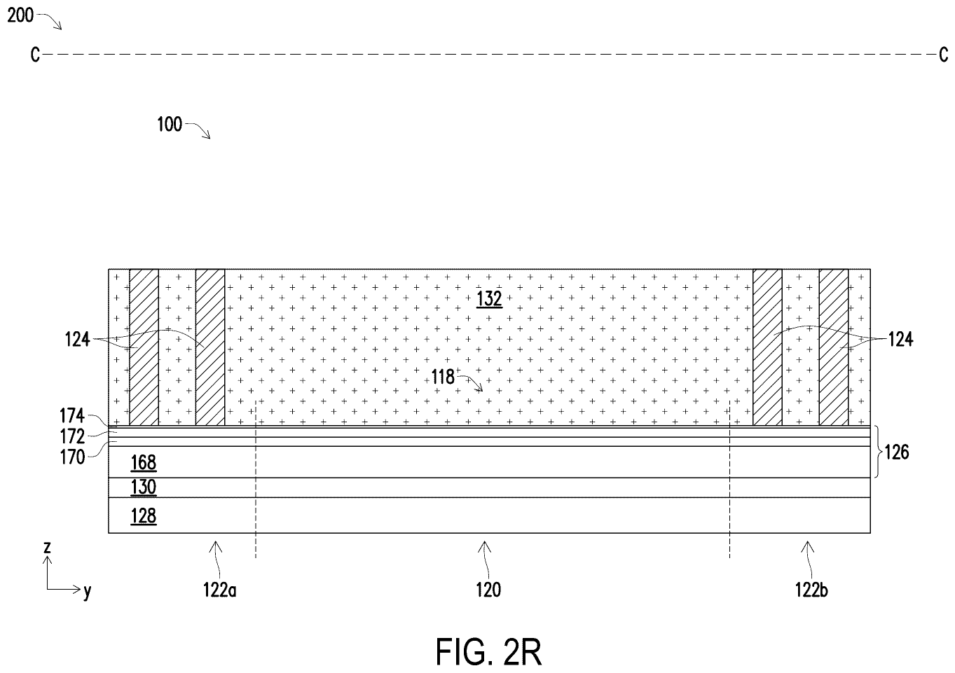

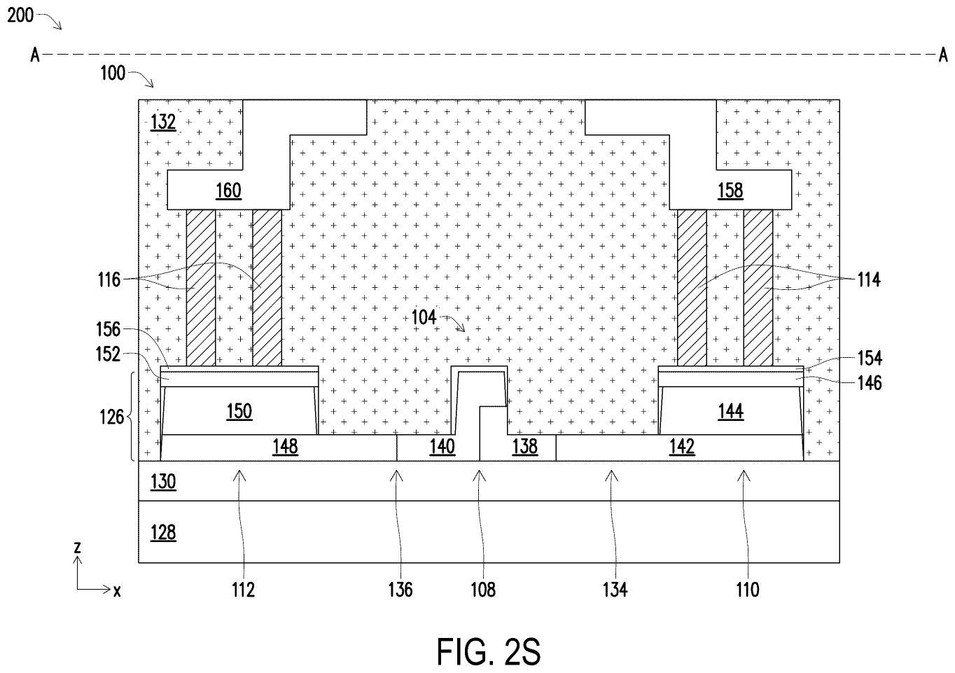

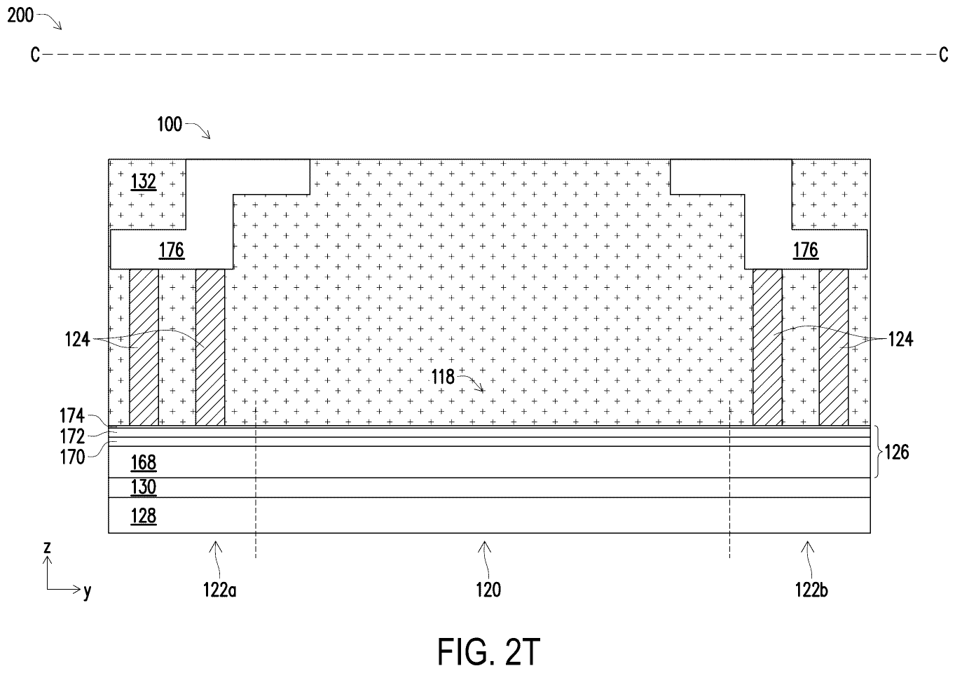

FIGS. 2A-2T are diagrams of an example implementation 200 of forming the semiconductor photonics device 100 (or a portion thereof) described herein. In some implementations, one or more of the semiconductor processing operations described in connection with the example implementation 200 may be performed using one or more semiconductor processing tools, such as a deposition tool, an exposure tool, a developer tool, an etch tool, a planarization tool, an ion implantation tool, and/or a wafer/die transport tool, among other examples. One or more of FIGS. 2A-2T are illustrated from cross-section views of the semiconductor photonics device 100 along the line A-A, the line B-B, and/or the line C-C in FIG. 1A.

Turning to FIGS. 2A and 2B, a substrate 202 may be provided. The substrate 202 may include a silicon on insulator (SOI) substrate that includes the semiconductor substrate 128 (e.g., a silicon (Si) substrate and/or another type of semiconductor substrate), the first dielectric layer 130 (e.g., a buried oxide or bottom oxide (BOX) layer and/or another type of insulator layer) over and/or on the semiconductor substrate 128, and the semiconductor layer 126 (e.g., a silicon (Si) layer and/or another type of semiconductor layer) over and/or on the first dielectric layer 130.

Alternatively, the semiconductor substrate 128 may be provided as a semiconductor wafer, and a deposition tool may be used to form the first dielectric layer 130 over and/or on the semiconductor substrate 128, and may form the semiconductor layer 126 over and/or on the first dielectric layer 130. A deposition tool may be used to form the first dielectric layer 130 using a chemical vapor deposition (CVD) technique, a physical vapor deposition (PVD) technique, an oxidation technique (e.g., a thermal oxidation technique), and/or another type of deposition technique. A deposition tool may be used to form the first semiconductor layer 126 using a CVD technique, a PVD technique, an epitaxy technique, and/or another type of deposition technique.

As shown in FIGS. 2C and 2D, portions of the semiconductor layer 126 are removed to form the optical modulator structure 104, the bus optical waveguide structure 106, and the modulator heater structure 118 from the semiconductor layer 126. In particular, the optical modulator structure 104, the bus optical waveguide structure 106, and the modulator heater structure 118 are formed in the semiconductor layer 126 such that the optical modulator structure 104, the bus optical waveguide structure 106, and the modulator heater structure 118 are physically connected in the semiconductor layer 126. The modulator heater structure 118 may be physically connected with the bus optical waveguide structure 106 through the connector section 162 of the semiconductor layer 126. The modulator heater structure 118 may be physically connected with the bus optical waveguide structure 106 and the optical modulator structure 104 through the connector sections 162 and 164 of the semiconductor layer 126. The closed-loop waveguide modulator structure 108 of the optical modulator structure 104 may be physically connected with the cathode 110 and the anode 112 of the optical modulator structure 104 by the connector sections 134 and 136, respectively.

In some implementations, a pattern in a hard mask layer is used to etch the semiconductor layer 126 to form the optical modulator structure 104, the bus optical waveguide structure 106, and the modulator heater structure 118. A deposition tool may be used to form the hard mask layer on the semiconductor layer 126 (e.g., using a CVD technique, a PVD technique, an atomic layer deposition (ALD) technique, an oxidation technique, and/or another type of deposition technique), and may form a photoresist layer on the hard mask layer (e.g., using a spin-coating technique and/or another type of deposition technique). An exposure tool may be used to expose the photoresist layer to a radiation source to form a pattern the photoresist layer. A developer tool may develop and remove portions of the photoresist layer to expose the pattern.

An etch tool may be used to etch the hard mask layer to transfer the pattern from the photoresist layer to the hard mask layer. An etch tool may be used to etch the semiconductor layer 126 based on the pattern in the hard mask layer to form the optical modulator structure 104, the bus optical waveguide structure 106, and the modulator heater structure 118 by removing portions of the semiconductor layer 126 based on the pattern. In some implementations, the etch operation includes a plasma etch operation, a wet chemical etch operation, and/or another type of etch operation. In some implementations, a photoresist removal tool is used to remove the remaining portions of the photoresist layer (e.g., using a chemical stripper, plasma ashing, and/or another technique). In some implementations, a planarization tool is used to remove the remaining portions of the hard mask layer using a chemical mechanical planarization (CMP) technique and/or another type of planarization technique.

As shown in FIGS. 2E and 2F, a first portion of the second dielectric layer 132 may be deposited around the optical modulator structure 104, the bus optical waveguide structure 106, and the modulator heater structure 118. The first portion of the second dielectric layer 132 may be referred to as a shallow trench isolation (STI) region of the second dielectric layer 132. A deposition tool may be used to deposit the first portion of the second dielectric layer 132 using a CVD technique, a PVD technique, an oxidation technique (e.g., a thermal oxidation technique), and/or another type of deposition technique. In some implementations, an STI liner is first deposited onto the semiconductor layer 126, and the first portion of the second dielectric layer 132 is deposited onto the STI liner.

As further shown in FIGS. 2E and 2F, a planarization tool may be used to perform a CMP operation and/or another type of planarization operation to planarize the first portion of the second dielectric layer 132. This may result in the top surface of the first portion of the second dielectric layer 132 being approximately co-planar with top surfaces of the optical modulator structure 104 (e.g., the closed-loop optical waveguide structure 108, the cathode 110, and the anode 112), the bus optical waveguide structure 106, and/or the modulator heater structure 118.

As shown in FIGS. 2G-2N, a plurality of regions of the semiconductor layer 126 may be doped with one or more types of dopants. The regions of the semiconductor layer 126 may be doped by ion implantation (e.g., using an ion implantation tool), by diffusion (e.g., using a diffusion tool), and/or by another type of doping operation.

As shown in FIG. 2G, a portion of the semiconductor layer 126 may be doped with a first dopant type to form the doped region 148 of the anode 112. A portion of the doped region 148 may also be included in the connector section 136 of the semiconductor layer 126.

As shown in FIG. 2H, a portion of the semiconductor layer 126 may be doped with a second dopant type (e.g., that is different from the first dopant type) to form the doped region 142 of the cathode 110. A portion of the doped region 142 may also be included in the connector section 134 of the semiconductor layer 126. In some implementations, the first dopant type includes one or more p-type dopants, and the second dopant type includes one or more n-type dopants. In some implementations, the first dopant type includes one or more n-type dopants, and the second dopant type includes one or more p-type dopants.

As shown in FIG. 2I, a portion of the semiconductor layer 126 may be doped with the first dopant type to form the doped region 140 of the closed-loop waveguide modulator structure 108. The doped region 140 may be formed laterally adjacent to the doped region 148. A portion of the doped region 140 may also be included in the connector section 136 of the semiconductor layer 126. As further shown in FIG. 2I, a portion of the semiconductor layer 126 may be doped with the first dopant type to form the doped region 150 of the anode 112. The doped region 150 may be formed above the doped region 148.

As shown in FIG. 2J, a portion of the semiconductor layer 126 may be doped with the first dopant type to form the doped region 170 of the modulator heater structure 118. The doped region 170 may be adjacent to an un-doped region 166 of the semiconductor layer 126 included in the bus optical waveguide structure 106, the closed-loop waveguide modulator structure 108, the connector section 162, and the connector section 164.

As shown in FIG. 2K, a portion of the semiconductor layer 126 may be doped with the second dopant type to form the doped region 138 of the closed-loop waveguide modulator structure 108. The doped region 138 may be formed laterally adjacent to the doped region 142. A portion of the doped region 138 may also be included in the connector section 134 of the semiconductor layer 126. As further shown in FIG. 2K, a portion of the semiconductor layer 126 may be doped with the second dopant type to form the doped region 144 of the cathode 110. The doped region 144 may be formed above the doped region 142.

As shown in FIG. 2L, a portion of the semiconductor layer 126 may be doped with the second dopant type to form the isolation region 168 of the modulator heater structure 118. The isolation region 168 may be located below and/or under the doped region 170 of the modulator heater structure 118. Moreover, isolation region 168 may be adjacent to the un-doped region 166 of the semiconductor layer 126 included in the bus optical waveguide structure 106, the closed-loop waveguide modulator structure 108, the connector section 162, and the connector section 164.

As shown in FIG. 2M, a portion of the semiconductor layer 126 may be doped with the first dopant type to form the doped region 152 of the anode 112. The doped region 152 may be formed above the doped region 150. As further shown in FIG. 2M, a portion of the semiconductor layer 126 may be doped with the second dopant type to form the doped region 146 of the cathode 110. The doped region 146 may be formed above the doped region 144.

As shown in FIG. 2N, a portion of the semiconductor layer 126 may be doped with the first dopant type to form the doped region 172 of the modulator heater structure 118. The doped region 172 may be formed above the doped region 170.

As shown in FIGS. 2O and 2P, the silicide layer 156 may be formed over and/or on the doped region 152 of the anode 112, the silicide layer 154 may be formed over and/or on the doped region 146 of the cathode 110, and the silicide layer 174 may be formed over and/or on the doped region 172 of the modulator heater structure 118. A deposition tool may be used to deposit the silicide layers 154, 156, and 174 using a CVD technique, a PVD technique, an ALD technique, and/or another deposition technique. In some implementations, forming the silicide layers 154, 156, and 174 may include depositing a layer of metal on each of the doped regions 146, 152 and 172, and annealing the layer of metal to cause the layer of metal to intermix with the semiconductor material of the doped regions 146, 152, and 172, thereby resulting in formation of the silicide layers 154, 156, and 174.

As shown in FIGS. 2Q and 2R, a second portion of the second dielectric layer 132 may be deposited on the optical modulator structure 104, the bus optical waveguide structure 106, and the modulator heater structure 118 such that the optical modulator structure 104, the bus optical waveguide structure 106, and the modulator heater structure 118 are encapsulated in the first dielectric layer 130 and the second dielectric layer 132. A deposition tool may be used to deposit the second portion of the second dielectric layer 132 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the second portion of the second dielectric layer 132.

As further shown in FIG. 2Q, contacts 114 may be formed on the cathode 110 such that the contacts 114 are physically connected with the silicide layer 154 of the cathode 110. Similarly, contacts 116 may be formed on the anode 112 such that the contacts 116 are physically connected with the silicide layer 156 of the anode 112.

To form the contacts 114 and 116, recesses may be formed in the second dielectric layer 132 over the cathode 110 and over the anode 112. In some implementations, a pattern in a photoresist layer is used to etch the second dielectric layer 132 to form the recesses. In these implementations, a deposition tool may be used to form the photoresist layer on the second dielectric layer 132. An exposure tool may be used to expose the photoresist layer to a radiation source to pattern the photoresist layer. A developer tool may be used to develop and remove portions of the photoresist layer to expose the pattern. An etch tool may be used to etch the second dielectric layer 132 based on the pattern to form the recesses in the second dielectric layer 132. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the second dielectric layer 132 based on a pattern.

A deposition tool may be used to deposit the material of the contacts 114 and 116 in the recesses using a CVD technique, a PVD technique, an ALD technique, an electroplating technique, another deposition technique described above in connection with FIG. 1, and/or another suitable deposition technique. The material of the contacts 114 and 116 may be deposited in one or more deposition operations. In some implementations, a seed layer is first deposited, and the material of the contacts 114 and 116 is deposited on the seed layer. In some implementations, a planarization tool may be used to planarize the contacts 114 and 116 after the contacts 114 and 116 are deposited.

As further shown in FIG. 2R, contacts 124 may be formed on the heater terminals 122a and 122b of the modulator heater structure 118 such that the contacts 124 are physically connected with the silicide layer 174 over the heater terminals 122a and 122b. To form the contacts 124, recesses may be formed in the second dielectric layer 132 over the heater terminals 122a and 122b. In some implementations, a pattern in a photoresist layer is used to etch the second dielectric layer 132 to form the recesses. In these implementations, a deposition tool may be used to form the photoresist layer on the second dielectric layer 132. An exposure tool may be used to expose the photoresist layer to a radiation source to pattern the photoresist layer. A developer tool may be used to develop and remove portions of the photoresist layer to expose the pattern. An etch tool may be used to etch the second dielectric layer 132 based on the pattern to form the recesses in the second dielectric layer 132. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the second dielectric layer 132 based on a pattern.

A deposition tool may be used to deposit the material of the contacts 124 in the recesses using a CVD technique, a PVD technique, an ALD technique, an electroplating technique, another deposition technique described above in connection with FIG. 1, and/or another suitable deposition technique. The material of the contacts 124 may be deposited in one or more deposition operations. In some implementations, a seed layer is first deposited, and the material of the contacts 124 is deposited on the seed layer. In some implementations, a planarization tool may be used to planarize the contacts 124 after the contacts 124 are deposited.

As shown in FIGS. 2S and 2T, a third portion of the second dielectric layer 132 may be deposited on the second portion of the second dielectric layer 132 and on the contacts 114, 116, and 124. A deposition tool may be used to deposit the third portion of the second dielectric layer 132 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the second dielectric layer 132 after the third portion of the second dielectric layer 132 is formed.

As further shown in FIG. 2S, a metallization layer 158 may be formed on the contacts 114 such that the metallization layer 158 is physically connected with the contacts 114. Similarly, a metallization layer 160 may be formed on the contacts 116 such that the metallization layer 160 is physically connected with the contacts 116.

To form the metallization layers 158 and 160, recesses may be formed in the second dielectric layer 132 over the contacts 114 and 116. In some implementations, a pattern in a photoresist layer is used to etch the second dielectric layer 132 to form the recesses. In these implementations, a deposition tool may be used to form the photoresist layer on the second dielectric layer 132. An exposure tool may be used to expose the photoresist layer to a radiation source to pattern the photoresist layer. A developer tool may be used to develop and remove portions of the photoresist layer to expose the pattern. An etch tool may be used to etch the second dielectric layer 132 based on the pattern to form the recesses in the second dielectric layer 132. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative for etching the second dielectric layer 132 based on a pattern.

A deposition tool may be used to deposit the material of the metallization layers 158 and 160 in the recesses using a CVD technique, a PVD technique, an ALD technique, an electroplating technique, another deposition technique described above in connection with FIG. 1, and/or another suitable deposition technique. The material of the metallization layers 158 and 160 may be deposited in one or more deposition operations. In some implementations, a seed layer is first deposited, and the material of the metallization layers 158 and 160 is deposited on the seed layer. In some implementations, a planarization tool may be used to planarize the metallization layers 158 and 160 after the metallization layers 158 and 160 are deposited.

As further shown in FIG. 2T, metallization layers 176 may be formed on the contacts 124 such that the metallization layers 176 are physically connected with the contacts 124. To form the metallization layers 176, recesses may be formed in the second dielectric layer 132 over the contacts 124. In some implementations, a pattern in a photoresist layer is used to etch the second dielectric layer 132 to form the recesses. In these implementations, a deposition tool may be used to form the photoresist layer on the second dielectric layer 132. An exposure tool may be used to expose the photoresist layer to a radiation source to pattern the photoresist layer. A developer tool may be used to develop and remove portions of the photoresist layer to expose the pattern. An etch tool may be used to etch the second dielectric layer 132 based on the pattern to form the recesses in the second dielectric layer 132. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the second dielectric layer 132 based on a pattern.

A deposition tool may be used to deposit the material of the metallization layers 176 in the recesses using a CVD technique, a PVD technique, an ALD technique, an electroplating technique, another deposition technique described above in connection with FIG. 1, and/or another suitable deposition technique. The material of the metallization layers 176 may be deposited in one or more deposition operations. In some implementations, a seed layer is first deposited, and the material of the metallization layers 176 is deposited on the seed layer. In some implementations, a planarization tool may be used to planarize the metallization layers 176 after the metallization layers 176 are deposited.

As indicated above, FIGS. 2A-2T are provided as an example. Other examples may differ from what is described with regard to FIGS. 2A-2T.

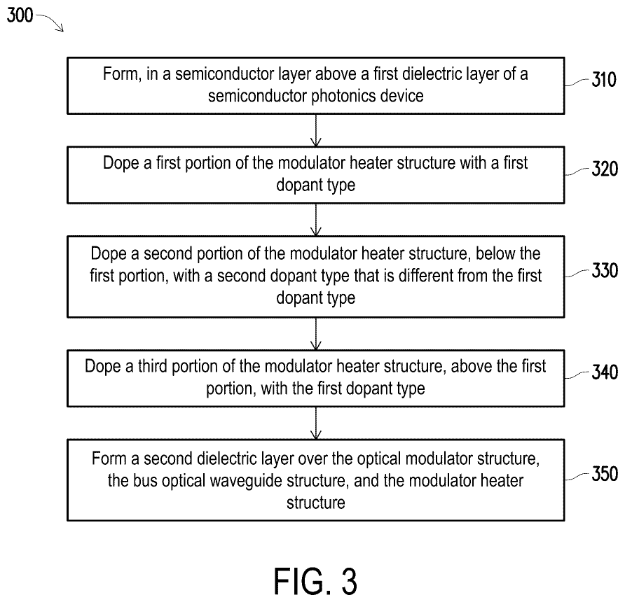

FIG. 3 is a flowchart of an example process 300 associated with forming a semiconductor photonics device described herein. In some implementations, one or more process blocks of FIG. 3 are performed using one or more semiconductor processing tools, such as a deposition tool, an exposure tool, a developer tool, an etch tool, a planarization tool, an ion implantation tool, a wafer/die transport tool, and/or another type of semiconductor processing tool.

As shown in FIG. 3, process 300 may include forming, in a semiconductor layer above a first dielectric layer of a semiconductor photonics device, an optical modulator structure, a bus optical waveguide structure adjacent to the optical modulator structure, and a modulator heater structure adjacent to the bus optical waveguide structure (block 310). For example, one or more semiconductor processing tools may be used to form, in a semiconductor layer 126 above a first dielectric layer 130 of a semiconductor photonics device 100, an optical modulator structure 104, a bus optical waveguide structure 106 adjacent to the optical modulator structure 104, and a modulator heater structure 118 adjacent to the bus optical waveguide structure 106, as described herein. In some implementations, the optical modulator structure 104, the bus optical waveguide structure 106, and the modulator heater structure 118 are physically connected in the semiconductor layer 126.

As further shown in FIG. 3, process 300 may include doping a first portion of the modulator heater structure with a first dopant type (block 320). For example, one or more semiconductor processing tools may be used to dope a first portion (e.g., a doped region 170) of the modulator heater structure 118 with a first dopant type, as described herein.

As further shown in FIG. 3, process 300 may include doping a second portion of the modulator heater structure, below the first portion, with a second dopant type that is different from the first dopant type (block 330). For example, one or more semiconductor processing tools may be used to dope a second portion (e.g., an isolation region 168) of the modulator heater structure 118, below the first portion, with a second dopant type that is different from the first dopant type, as described herein.

As further shown in FIG. 3, process 300 may include doping a third portion of the modulator heater structure, above the first portion, with the first dopant type (block 340). For example, one or more semiconductor processing tools may be used to dope a third portion (e.g., a doped region 172) of the modulator heater structure 118, above the first portion, with the first dopant type, as described herein.

As further shown in FIG. 3, process 300 may include forming a second dielectric layer over the optical modulator structure, the bus optical waveguide structure, and the modulator heater structure (block 350). For example, one or more semiconductor processing tools may be used to form a second dielectric layer 132 over the optical modulator structure 104, the bus optical waveguide structure 106, and the modulator heater structure 118, as described herein.

Process 300 may include additional implementations, such as any single implementation or any combination of implementations described below and/or in connection with one or more other processes described elsewhere herein.

In a first implementation, process 300 includes forming a silicide layer 174 on the third portion of the modulator heater structure 118, where forming the second dielectric layer 132 includes forming, prior to forming the silicide layer 174, a first portion of the second dielectric layer 132 such that a top surface of the first portion of the second dielectric layer 132 and a top surface of the modulator heater structure 118 are approximately co-planar, and forming a second portion of the second dielectric layer 132 after forming the silicide layer 174.

In a second implementation, alone or in combination with the first implementation, forming the second dielectric layer 132 includes forming a first portion of the second dielectric layer 132 prior to doping the first portion of the modulator heater structure 118, and forming a second portion of the second dielectric layer 132 after doping the third portion of the modulator heater structure 118.

In a third implementation, alone or in combination with one or more of the first and second implementations, the bus optical waveguide structure 106 is between the optical modulator structure 104 and the modulator heater structure 118 in the semiconductor layer 126.

In a fourth implementation, alone or in combination with one or more of the first through third implementations, forming the modulator heater structure 118 includes forming the modulator heater structure 118 such that the modulator heater structure 118 is located outside a perimeter of the optical modulator structure 104.

In a fifth implementation, alone or in combination with one or more of the first through fourth implementations, a first dopant concentration of the first dopant type in the first portion of the modulator heater structure 118 is less than a second dopant concentration of the first dopant type in the third portion of the modulator heater structure 118.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

In this way, a bus optical waveguide structure, an optical modulator structure, and a modulator heater structure are formed from a semiconductor layer of a semiconductor photonics device such that the bus optical waveguide structure, the optical modulator structure, and the modulator heater structure are contiguous and physically connected. The physical connection between the optical modulator structure and the modulator heater structure provides a direct path for heat to be provided from the modulator heater structure to the optical modulator structure through the semiconductor layer. An isolation region, which may include a doped region of the semiconductor layer, is included between the modulator heater structure and the bus optical waveguide structure and the optical modulator structure. The isolation region electrically isolates the modulator heater structure and the optical modulator structure. Thus, the modulator heater structure is physically connected to, and electrically isolated from, the optical modulator structure.

As described in greater detail above, some implementations described herein provide a semiconductor photonics device. The semiconductor photonics device includes a bus optical waveguide structure. The semiconductor photonics device includes an optical modulator structure adjacent to a first side of the bus optical waveguide structure. The semiconductor photonics device includes a modulator heater structure adjacent to a second side of the bus optical waveguide structure opposing the first side, where the bus optical waveguide structure, the optical modulator structure, and the modulator heater structure are physically connected in a semiconductor layer of the semiconductor photonics device, and where the modulator heater structure comprises an isolation region between a heater section of the modulator heater structure and the bus optical waveguide structure.

As described in greater detail above, some implementations described herein provide a semiconductor photonics device. The semiconductor photonics device includes a bus optical waveguide structure extending in a first direction in the semiconductor photonics device. The semiconductor photonics device includes a closed-loop optical modulator structure adjacent to a first side of the bus optical waveguide structure. The semiconductor photonics device includes a modulator heater structure extending in the first direction and adjacent to a second side of the bus optical waveguide structure opposing the first side. The bus optical waveguide structure, the closed-loop optical modulator structure, and the modulator heater structure are arranged in a second direction in the semiconductor photonics device that is approximately perpendicular to the first direction. The bus optical waveguide structure and the modulator heater structure are physically connected by a first connector section between the bus optical waveguide structure and the modulator heater structure. The bus optical waveguide structure and the closed-loop optical modulator structure are physically connected by a second connector section between the bus optical waveguide structure and the closed-loop optical modulator structure. The modulator heater structure comprises an isolation region between a heater section of the modulator heater structure and the first connector section.

As described in greater detail above, some implementations described herein provide a method. The method includes forming, in a semiconductor layer above a first dielectric layer of a semiconductor photonics device, an optical modulator structure, a bus optical waveguide structure adjacent to the optical modulator structure, and a modulator heater structure adjacent to the bus optical waveguide structure. The optical modulator structure, the bus optical waveguide structure, and the modulator heater structure are physically connected in the semiconductor layer. The method includes doping a first portion of the modulator heater structure with a first dopant type. The method includes doping a second portion of the modulator heater structure, below the first portion, with a second dopant type that is different from the first dopant type. The method includes doping a third portion of the modulator heater structure, above the first portion, with the first dopant type. The method includes forming a second dielectric layer over the optical modulator structure, the bus optical waveguide structure, and the modulator heater structure.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a bus optical waveguide structure;
an optical modulator structure adjacent to a first side of the bus optical waveguide structure; and
a modulator heater structure adjacent to a second side of the bus optical waveguide structure opposing the first side,
wherein the bus optical waveguide structure, the optical modulator structure, and the modulator heater structure are physically connected in a semiconductor layer of the semiconductor photonics device, and
wherein the modulator heater structure comprises an isolation region between a heater section of the modulator heater structure and the bus optical waveguide structure.

2. The semiconductor photonics device of claim 1, wherein the isolation region comprises a doped region of the semiconductor layer.

3. The semiconductor photonics device of claim 2, wherein the isolation region comprises a first region of the semiconductor layer that includes a first dopant type; and
wherein the heater section comprises one or more second regions of the semiconductor layer that includes a second dopant type that is different from the first dopant type.

4. The semiconductor photonics device of claim 3, wherein the first region and the one or more second regions are vertically arranged in the semiconductor photonics device.

5. The semiconductor photonics device of claim 1, wherein the heater section extends approximately parallel to the bus optical waveguide structure.

6. The semiconductor photonics device of claim 5, wherein the modulator heater structure comprises heater terminals at opposing ends of the heater section.

7. The semiconductor photonics device of claim 5, wherein opposing ends of the heater section are approximately aligned with opposing sides of a waveguide of the optical modulator structure.

8. A semiconductor photonics device, comprising:
a bus optical waveguide structure extending in a first direction in the semiconductor photonics device;
a closed-loop optical modulator structure adjacent to a first side of the bus optical waveguide structure; and
a modulator heater structure extending in the first direction and adjacent to a second side of the bus optical waveguide structure opposing the first side,
wherein the bus optical waveguide structure, the closed-loop optical modulator structure, and the modulator heater structure are arranged in a second direction in the semiconductor photonics device that is approximately perpendicular to the first direction,
wherein the bus optical waveguide structure and the modulator heater structure are physically connected by a first connector section between the bus optical waveguide structure and the modulator heater structure,
wherein the bus optical waveguide structure and the closed-loop optical modulator structure are physically connected by a second connector section between the bus optical waveguide structure and the closed-loop optical modulator structure, and
wherein the modulator heater structure comprises an isolation region between a heater section of the modulator heater structure and the first connector section.

9. The semiconductor photonics device of claim 8, wherein the isolation region is under the heater section;
wherein a top of the isolation region is in physical contact with a doped region of the heater section;
wherein a side of the isolation region is in physical contact with the first connector section; and
wherein the side of the isolation region is facing the bus optical waveguide structure and the closed-loop optical modulator structure.

10. The semiconductor photonics device of claim 8, wherein the bus optical waveguide structure, the closed-loop optical modulator structure, the modulator heater structure, the first connector section, and the second connector section are physically connected in a semiconductor layer of the semiconductor photonics device.

11. The semiconductor photonics device of claim 8, wherein the modulator heater structure comprises:
a first doped semiconductor region having a first dopant concentration; and
a second doped semiconductor region, on the first doped semiconductor region, having a second dopant concentration that is greater than the first dopant concentration.

12. The semiconductor photonics device of claim 11, wherein the first doped semiconductor region is on top of the isolation region; and
wherein the first doped semiconductor region is between the isolation region and the second doped semiconductor region.

13. The semiconductor photonics device of claim 11, wherein the modulator heater structure comprises:
a silicide layer on the second doped semiconductor region.

14. The semiconductor photonics device of claim 8, wherein the bus optical waveguide structure is between the closed-loop optical modulator structure and the isolation region.

15. A method, comprising:
forming, in a semiconductor layer above a first dielectric layer of a semiconductor photonics device:
an optical modulator structure,
a bus optical waveguide structure adjacent to the optical modulator structure, and
a modulator heater structure adjacent to the bus optical waveguide structure,
wherein the optical modulator structure, the bus optical waveguide structure, and the modulator heater structure are physically connected in the semiconductor layer;
doping a first portion of the modulator heater structure with a first dopant type;
doping a second portion of the modulator heater structure, below the first portion, with a second dopant type that is different from the first dopant type; and
doping a third portion of the modulator heater structure, above the first portion, with the first dopant type; and
forming a second dielectric layer over the optical modulator structure, the bus optical waveguide structure, and the modulator heater structure.

16. The method of claim 15, further comprising:
forming a silicide layer on the third portion of the modulator heater structure,
wherein forming the second dielectric layer comprises:
forming, prior to forming the silicide layer, a first portion of the second dielectric layer such that a top surface of the first portion of the second dielectric layer and a top surface of the modulator heater structure are approximately co-planar; and
forming a second portion of the second dielectric layer after forming the silicide layer.

17. The method of claim 15, wherein forming the second dielectric layer comprises:
forming a first portion of the second dielectric layer prior to doping the first portion of the modulator heater structure; and
forming a second portion of the second dielectric layer after doping the third portion of the modulator heater structure.

18. The method of claim 15, wherein the bus optical waveguide structure is between the optical modulator structure and the modulator heater structure in the semiconductor layer.

19. The method of claim 15, wherein forming the modulator heater structure comprises:
forming the modulator heater structure such that the modulator heater structure is located outside a perimeter of the optical modulator structure.

20. The method of claim 15, wherein a first dopant concentration of the first dopant type in the first portion of the modulator heater structure is less than a second dopant concentration of the first dopant type in the third portion of the modulator heater structure.
